(19) United States
(12) Patent Application Publication
(10) Pub. No.: US 2016/0146497 A1
(43) Pub. Date: May 26, 2016

(54) MAINTAINING AN ATTRIBUTE OF A BUILDING

(71) Applicant: Honeywell International Inc., Morristown, NJ (US)

(72) Inventors: Christopher M. Chapman, Horsham (GB); Karel Macek, Prague (CZ)

(21) Appl. No.: 14/947,561

(22) Filed: Nov. 20, 2015

Related U.S. Application Data
(60) Provisional application No. 62/082,349, filed on Nov. 20, 2014.

(51) Int. Cl. F24F 11/00; G05B 13/02

(52) U.S. Cl. CPC F24F 11/0012; G05B 13/026; F24F 2011/0058

(57) ABSTRACT

Methods, computer readable media, and systems for maintaining an attribute of a building are described herein. One method includes monitoring an attribute of a building, predicting a behavior of the attribute based on a weather forecast, and adjusting the attribute to maintain the attribute within a comfort range relative to a set point for the attribute during a time period based on the predicted behavior.

### TECHNICAL FIELD

The present disclosure relates to systems, methods, and computer readable media for maintaining an attribute of a building.

### BACKGROUND

Building attributes, such as, for instance, the internal temperature of the building, can be affected by weather conditions. For example, a building can experience solar gain (e.g., an increase in the temperature within the building) due to solar radiation absorbed by the building during a sunny day, and a building can experience radiant cooling (e.g., a decrease in temperature within the building) due to thermal energy transfer to the outside air during a cool cloudy day. Building control systems (e.g., heating, ventilation, and air conditioning systems) can monitor and/or condition (e.g., alter the properties of) the building's attributes to improve and/or maintain the comfort of the building for its occupants.

The cost of conditioning building attributes, however, can be significant and scale with the size of the building. Efficient conditioning of building attributes can reduce the costs associated with conditioning the building attributes.

Previous attempts to reduce the costs associated with conditioning a building attribute can include the use of programmable thermostats that allow the selection of a set point and/or set points for the attribute. That is, previous attempts to reduce the costs associated with conditioning a building attribute can be based on fixed setpoints throughout the day and/or a fixed schedule of setpoints. Building control systems can allow a user to program a set point for certain times of the day, and the thermostat can condition the attribute so that it achieves the set point during those times.

Such control strategies, however, are reactive to the current state of the building attribute and do not consider the effect of external weather conditions. As a result, utilizing these strategies can result in a building being, for example, heated to a set point at the beginning of an occupancy period only to have solar radiation heat the building beyond the set point later in the work day occupancy period as the day becomes warmer and more sunny thereby heating the building. The result is an uncomfortable temperature within the building and/or the use of additional energy to cool the building back to the set point.

### BRIEF DESCRIPTION OF THE DRAWINGS

FIG. 1 illustrates an example system for maintaining an attribute of a building in accordance with one or more embodiments of the present disclosure.

FIG. 2 illustrates an example temperature and energy consumption graph in accordance with one or more embodiments of the present disclosure.

FIG. 3 illustrates a diagram of an example computing device in accordance with one or more embodiments of the present disclosure.

### DETAILED DESCRIPTION

Methods, computer readable media, and systems for maintaining an attribute of a building are described herein. A building attribute can include a physical property and/or comfort condition. A building attribute can include an attribute of an internal space of the building. For example, one or more embodiments include monitoring an attribute of a building, predicting a behavior of the attribute based on a weather forecast, and adjusting the attribute to maintain the attribute within a comfort range relative to a set point for the attribute during a time period based on the predicted behavior.

Embodiments of the present disclosure can proactively generate a building attribute conditioning schedule that accounts for an effect of a weather condition on an attribute on a building. The embodiments of the present disclosure can generate and/or execute the building attribute conditioning schedule to maintain the attribute within a comfort range (e.g., a predetermined attribute range associated with a determination of comfort with regard to the attribute such as a range of temperatures determined to be comfortable for human beings working in an environment). The embodiments of the present disclosure can include generating and/or executing a building attribute conditioning schedule in a manner that is more energy efficient than conventional methods and/or offers significant energy consumption savings by accounting for the effects of weather conditions on the behavior of the attributes.

For example, embodiments of the present disclosure can generate an energy savings over conventional methods by generating and/or executing a building attribute conditioning schedule that uses less energy by heating the building to a temperature below a set point and/or a comfort range within the comfort band and utilizing solar radiation of a sunny day to compliment the maintenance of the temperature (e.g., allow the solar radiation to complete the heating of the building to a set point, prevent overheating through solar gain, prevent cooling to reverse solar gain, etc.).

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice the embodiments of this disclosure. It is to be understood that other embodiments may be utilized and that process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” refers to one or more of such things. For example, “a number of buildings” can refer to one or more buildings.

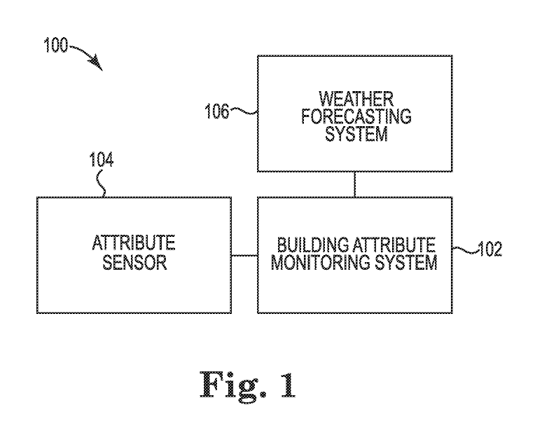

FIG. 1 illustrates an example of a building automation and control system 100 for maintaining an attribute of a building in accordance with one or more embodiments of the present disclosure. The system 100 is shown to include a control system 102, attribute sensor 104, and a weather forecasting system 106.

A control system 102 can include a building attribute monitoring system. The control system 102 can include a heating, ventilating, and/or air conditioning control module. The control system 102 can be a thermostat for a building, such as a programmable thermostat. The control system 102 can receive a number of inputs (e.g., a weather forecast from weather forecasting system 106, data from the attribute sensor 104, etc.) and utilize the inputs in managing a building attribute.

The control system 102 can send and/or receive data over a network (not shown in FIG. 1). The network can be a wired or wireless network, such as, for instance, a wide area network (WAN) such as the Internet, a local area network (LAN), a personal area network (PAN), a campus area network (CAN), or metropolitan area network (MAN), among other types of networks.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, network 106 can tie a number of computing devices together to form a distributed control network.

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

An attribute sensor 104 can include a device that detects an attribute and/or a change in an attribute and provides a corresponding output. That is, an attribute sensor 104 can measure an attribute and report that measurement as some form of an output. As used herein, an attribute includes a physical property of the building and/or the matter within the building. For example, an attribute can include a temperature of the air within a building (e.g., an internal temperature) and/or the humidity of the air within the building. In such examples, the attribute sensor 104 can include a thermometer (e.g., bimetallic mechanical or electrical, expanding pellets, electronic thermistors, semiconductor devices, electrical thermocouples, etc.) to measure temperature and/or a psychrometer, hygrometer, and/or humidistat to measure humidity. The attribute sensor 104 can include a temperature sensor measuring the internal temperature of the building during a weather condition. The attribute sensor 104 can additionally measure current weather conditions outside of the building.

The attribute sensor 104 can be one of a network of sensors located throughout the building. For example, the attribute sensor 104 can be a sensor for a portion of a building, a room, a zone, a floor, or a building. The attribute sensor 104 can be part of the control system 102 and/or can generate an output that serves as an input to the control system 102. The attribute sensor 104 can provide substantially real time measurements of the attribute and/or provide periodic measurements of the attribute.

The control system 102 can monitor an attribute of the building by receiving data from the corresponding attribute sensor 104. For example, the control system 102 can monitor the internal temperature of the building by receiving data from a temperature sensor and/or a network of temperature sensors inside of the building.

The system 100 can include a weather forecasting system 106. The weather forecasting system 106 can include a weather forecast (e.g., a prediction of a weather condition for a location during a period of time). As used herein, a weather condition includes air temperature, wind speed, wind direction, ultraviolet index, type of weather (e.g., cloudy, rainy, sunny, snowy, thunderstorms, etc.), cloud cover, humidity, dew point temperature, visibility, precipitation, chances of types of weather, atmospheric pressure, radar information, etc. The weather forecast can include both current weather conditions and predicted future weather conditions. The weather forecast can include weather conditions for the location that the building is located in. The weather forecast can include predicted weather conditions for a time period including coming minutes, hours, days, and/or weeks.

The weather forecasting system 106 can monitor and/or receive a weather forecast. The weather forecast can be generated by and received (e.g., retrieved) by a weather forecasting service. For example, the weather forecast can be generated by a weather forecasting service and received via a network (e.g., a wired or wireless network) by the weather forecasting system 106 and provided to a control system 102. For example, the weather forecast can be received by the weather forecasting system 106 as an input via the network. In some embodiments of the present disclosure the weather forecast can be generated by the weather forecasting system 106.

The weather forecast can be generated by weather forecasting instrumentation (e.g., radar, air mass tracking technologies, sensors, etc.). In some embodiments of the present disclosure, the weather forecasting system 106 and/or weather forecasting instrumentation can be part of the weather forecasting service. In some embodiments of the present disclosure the weather forecasting system 106 and/or weather forecasting instrumentation can be part of the control system 102.

The weather forecast can be received in substantially real time and/or periodically (e.g., hourly, daily, weekly, when a weather forecast is updated, when a weather alert or warning is generated by a weather forecasting service, etc.). The weather forecast can be updated in substantially real time and/or periodically.

The control system 102 can predict the behavior of an attribute of the building based on the weather forecast. For example, the control system 102 can predict the behavior of the attribute based on a model of the building's response to a weather condition and/or a forecast of weather conditions. The model can be time series and/or differential equation based and can predict the evolution of the temperature of a building over the whole day based upon the forecast of weather conditions. The control system 102 can generate the model. The model can include a model of the building and/or how an attribute of the building behaves under (e.g., reacts to) certain weather conditions.

The model can include a thermal response model of the building and/or its attributes. A thermal response model can include a mathematical model that expresses thermal properties and behaviors of the building and the attributes under a plurality of weather conditions. The thermal response model can be based on a building property (e.g., thermal properties of the materials used in the construction of the building, thermal properties of the contents of the building, age of the building, blueprints for the building, heating, ventilation, and air conditioning specifications, a number of occupants of the building, whether the building is a residential or commercial building, etc.).

Alternatively and/or additionally, the thermal response model can be based on a historical behavior (e.g., internal temperature) of a building attribute during a corresponding weather condition. That is, the thermal model can be based on historical attribute sensor readings 104 and historical weather conditions and/or historical weather forecasts temporally coincident with the historical attribute sensor readings 104. For example, if on a cloudy day with temperature patterns ranging from 48° Fahrenheit (F) in the morning, to 50° F. in the afternoon, to 49° F. in the late afternoon, the temperature in the building dropped at a rate of 5° F. per hour without attribute conditioning according to measurements received from an attribute sensor 104 collected contemporaneous with the weather conditions, then a thermal response model can be constructed that models a 5° F. per hour temperature loss within the building under similar weather conditions. That is, the thermal response model can model the same rate of change of a temperature as is experienced by the building under the same weather conditions reflected in the model.

The model of the building's response to weather conditions can be a dynamic model that continues to be updated based on how the building attributes respond to a number of weather conditions based on received measurements from the attribute sensor 104, updated measurements from the attribute sensor 104, weather forecasts, updated weather forecasts, and/or weather conditions contemporaneous with measurements/updated measurements received from the attribute sensor 104. For example, the model can be a thermal response model updated continuously based on an updated internal building temperature reading from an attribute sensor 104, an updated weather condition, and/or and updated weather forecast.

The control system 102 can generate a thermal response model of the building and/or its attributes by incorporating the response of the building and/or its attributes to a plurality of weather conditions. For example, the control system 102 can generate a thermal response model of the building by incorporating the behavior of the internal temperature of the building during a number of weather conditions and/or during implementation of a number of conditioning measures (e.g., heating, cooling, ventilating, dehumidifying, etc.) within the building during the weather conditions.

The model can utilize differential equations to model the response of building attributes where the coefficients of the response take into account measurements received from the attribute sensor 104 and measurements of weather conditions (e.g., from weather condition sensors, from a contemporaneous weather forecast, etc.). The attribute sensor 104 and measurements of weather conditions can be incorporated into the coefficients and mathematically processed to produce a descriptive aspect of the model.

Predicting a behavior of an attribute of the building can include applying the model to a weather forecast. For example, the control system 102 can predict a behavior of an attribute based on a weather condition included in a weather forecast for the area in which the building is located (e.g., local forecasts). Weather conditions can be identified within the weather forecast and the control system 102 can predict how a building attribute will respond to the weather condition based on the model. For example, the weather forecast can include a forecast of sunny temperatures with a high of 50° F. and a low of 48° F. The attribute sensor 104 can generate a measurement of the current internal temperature of the building at 70° F. The model can predict a temperature loss based on historical temperature loss under similar or identical weather conditions. Therefore, the control system 102 can predict that the internal temperature of the building will decrease without conditioning to an equilibrium between heat losses to outside air, and heat gains from solar radiation and internal thermal capacities, etc.

Predicting the behavior of the building attribute can include predicting the behavior of the attribute over a period of time. For example, the building can be a commercial building (e.g., office building, factory, warehouse, hotel, etc.) and/or a residential building (e.g., home, apartment, etc.) and the period of time can be a period of occupancy. The control system 102 can, therefore, predict the behavior of the attribute during occupancy periods so that it can condition the building appropriately to maintain comfort conditions. Weather conditions can be diverse over an occupancy period and the control system 102 can predict attribute behavior for an appropriate time scale (e.g., minutes, hours, days, weeks, etc.) corresponding to a weather forecast and/or a predicted time scale of a weather event included in the weather forecast. The control system 102 can also modify its predictions based on updated measurements from the attribute sensor 104 and/or updated weather forecasts and/or weather conditions being added to the thermal response model. For example, when the weather forecast is retrieved and/or updated daily, the prediction of a behavior of an attribute can also be updated daily to reflect changes in the weather forecast.

Different buildings and/or different occupants can have different comfort conditions associated therewith. That is, for a given building a preferred or targeted attribute measurement can be defined. For example, buildings and/or occupants can have unique set points and/or comfort ranges. A set point can include a targeted attribute (e.g., internal temperature) to achieve and/or maintain in a building. A comfort range can include a targeted attribute (e.g., temperature) range representing attributes (e.g., temperatures) to which people are generally accustomed, such as temperatures at which the air feels neither hot nor cold relative to the set point.

The targeted attribute measurement can be received by the control system 102. For example, the control system 102 can receive an occupancy period (e.g., a period of time during which the building will be occupied), a set point temperature, and/or a comfort range of temperatures. Alternatively and/or additionally, the control system 102 can generate the comfort range of temperatures based on the set point.

In an example embodiment of the present disclosure, the control system 102 can receive as an input from a user an indication of an occupancy period for a commercial building of 7:00 AM-5:30 PM and a set point temperature of 70° F. for the building during the occupancy period. The control system 102 can also generate or receive a comfort range of temperatures. The comfort range of temperatures can define a targeted range of measurements of the temperature attribute relative to the set point that represent. The range of targeted temperatures can include temperatures deviating from the set point but remaining in a range that occupants perceive as comfortable (e.g., attribute measurements bounding the attribute set point that will not disrupt the perceived comfort of occupants).

The control system 102 can generate a building conditioning schedule. A conditioning schedule can include a heating, ventilation, and/or air-conditioning schedule (e.g., a schedule for heating and/or cooling the building). The conditioning schedule can be a schedule to maintain a building attribute. For example, the conditioning schedule can include a heating, ventilation, and/or air-conditioning schedule to maintain the internal temperature of the building. The conditioning schedule can include an attribute conditioning program to maintain the building attribute within a comfort range relative to a set point of the attribute during a time (e.g., occupancy) period. The comfort range can include a predetermined targeted range of attributes bounding an attribute set point. For example, the conditioning schedule can include a heating, ventilation, and/or air-conditioning schedule to maintain the internal temperature of a building in a predetermined temperature range of 61° F.-79° F. relative to a 70° F. targeted internal building temperature set point. The conditioning schedule can include a time period over which to condition the attribute. The time period can include an occupancy period of the building such as 7:00 AM-5:30 PM.

The building conditioning schedule can be based on a predicted behavior of the attribute. For example, the building conditioning schedule can be based on the behavior of the internal temperature of the building to a number of weather conditions which can be included in a weather forecast.

Generating the schedule can include calculating a quantity and/or type of conditioning needed to counteract and/or supplement the effects of the forecasted weather condition to achieve and/or maintain the targeted comfort range. The control system 102 can calculate the energy consumption of a building conditioning schedule. The control system 102 can generate a building conditioning schedule designed to conserve energy use based on the energy consumption calculation. A building conditioning schedule can conserve energy by utilizing forecasted weather conditions to compliment the conditioning of the building. The energy consumption associated with a building conditioning schedule can be reduced in this manner since the weather conditions contribute to conditioning of the attribute in lieu of energy consuming attribute conditioning measures.

For example, the control system 102 can generate the conditioning schedule to heat the building to a set point of 70° F. during the occupancy of the building. In this example, during the occupancy of the building the weather forecast contains weather conditions that have been predicted via the model to cause the building temperature to rise at 2° F. per hour, a comfort range of 61° F.-79° F. has been calculated based on the 70° F. set point, the internal building temperature is measured at 58° F. via an attribute sensor 104, and the occupancy period for the building is 7:00 AM-5:00 PM. The control system 102 can generate an energy efficient conditioning schedule that will heat the building temperature 1° F. to 59° F. by 7:00 AM and allow the weather condition to heat the building to 61° F. by 8:00 AM, 63° F. by 9:00 AM, 65° F. by 10:00 AM, 67° F. by 11:00 AM, 69° F. by 12:00 PM, 71° F. by 1:00 PM, 73° F. by 2:00 PM, 75° F. by 3:00 PM, and 77° F. by 5:00 PM without additional conditioning.

The control system 102 can generate the building conditioning schedule periodically. For example, the building conditioning schedule can be generated hourly, daily, when the weather forecast is updated, when a weather alert or warning is generated by a weather forecasting service, when the thermal response model is updated, etc.

The control system 102 can execute the schedule. Executing the schedule can include adjusting (e.g., via heating, ventilation, and/or air-conditioning, etc.) the attribute to maintain it within a comfort range relative to an attribute set point during a time period based on the predicted behavior. Extending the example of the preceding paragraph, the control system 102 can execute the schedule to maintain the temperature of the building within the predetermined targeted temperature comfort range relative to the set point during an occupancy period of the building based on the predicted behavior of the temperature to a weather condition included in the weather forecast. As described in the example, the control system 102 can adjust (e.g., heat) the internal building temperature to below the set point and/or below the predetermined comfort range for the start of an occupancy period sufficient to allow the weather condition to bring the temperature to the set point and/or prevent the weather condition from causing the temperature to exceed the comfort range during the occupancy period requiring the consumption of more energy to cool the building. In essence, the control system 102 can generate a conditioning schedule that marginally compromises comfort at the beginning of an occupancy period in order to achieve overall comfort across the occupancy period while using less energy to accomplish the comfort.

The total energy consumption involved in such a schedule would be the energy used to raise the internal building temperature 1° F. to 59° F. by 7:00 AM. Conventional methods of heating the building to the 70° F. set point by 7:00 AM would have involved the consumption of not only enough energy to raise the internal building temperature 12° F. to the 70° F. set point by 7:00 AM, but also the energy consumed in cooling the building at a rate of 2° F. per hour to counteract the behavior of the temperature in response to the weather condition for the subsequent ten hours. The control system 102 can calculate the energy consumed in raising the internal building temperature 1° F. to 59° F. is less than the energy consumed in raising the internal building temperature 12° F. to the 70° F. and cooling the building at a rate of 2° F. per hour for ten hours and generate the schedule according to the method utilizing less energy. In some examples, the control system 102 can present schedule options and/or their corresponding energy requirements to a user interface for selection of a schedule to ultimately execute.

The control system 102 can generate the building conditioning schedule responsive to receiving an input. For example, the control system 102 can generate the conditioning schedule responsive to receiving an attribute sensor measurement 104 and/or a weather forecast with an updated weather condition. Alternatively the control system 102 can generate the attribute conditioning schedule upon generating the prediction of the behavior of the attribute based on the weather forecast.

Additionally, as discussed above, the predicted attribute behavior and the weather forecast can be updated. Therefore, the conditioning schedule generated by the control system 102 can be updated. The update can occur responsive to generating an updated prediction of the attribute behavior and/or to receiving an updated weather forecast.

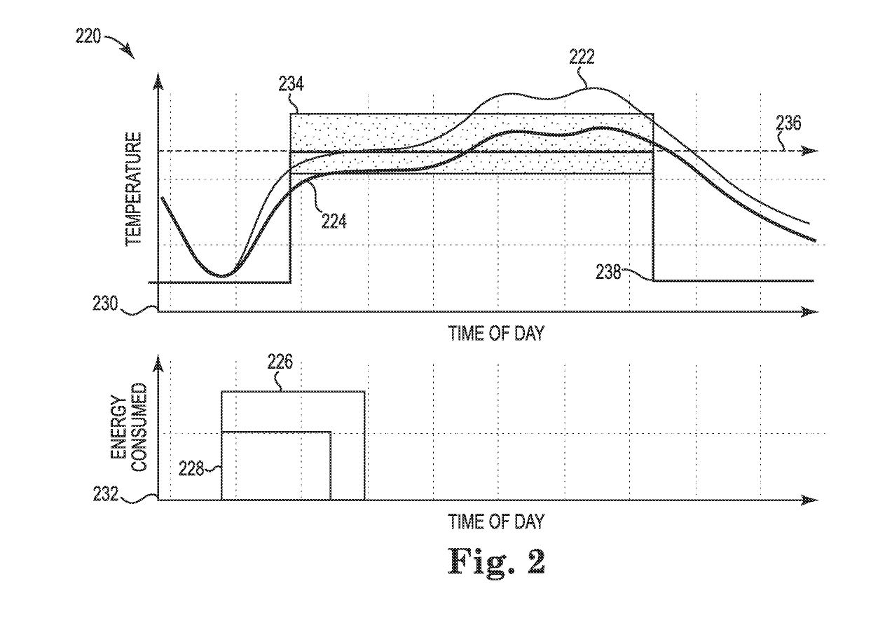

FIG. 2 illustrates an example temperature and energy consumption graph 220 in accordance with one or more embodiments of the present disclosure. The temperature and energy consumption graph 220 illustrates a comparison between the energy consumption and temperature difference resulting from a conventional method (e.g., 222, 226) of heating a building and a schedule generated and executed according to the present disclosure (e.g., 224, 228).

The example depicted in graph 220 is an example of a commercial building in a temperate climate. A commercial building in a temperate climate can have a heating element but lack a chilling element to condition the internal temperature of the building. Alternatively, in a temperate climate the building can have a chilling element but the chilling element can be utilized sparingly to condition the building in unseasonably hot weather conditions that cause the internal building temperature to drastically depart from a comfort range 234. Therefore, in the illustrated example, where the temperature exceeds a comfort range 234 it is allowed to remain elevated without conditioning the internal temperature downward to within the comfort range 234. Such an elevated internal building temperature can create discomfort among the occupants of the building.

The upper portion of the graph 220 includes a temperature versus time of day graph 230 having an x-axis including the time of day and a y-axis including the internal temperature of the building. The temperature versus time of day graph 230 illustrates the set point temperature 236 for the building. As discussed above, the set point temperature 236 is the targeted internal temperature to maintain within the building.

The temperature versus time of day graph 230 also illustrates the occupancy period of the building via an occupancy line 238. The occupancy line 238 indicates that the building has low or no occupancy during periods where it diverges from the set point 236. Where the occupancy line 238 converges to and is coincident with the set point 238 a period of normal workday occupancy is indicated.

The temperature versus time of day graph 230 further illustrates the comfort range 234 of the internal building temperature relative to the set point 236. The comfort range 234 includes the range of targeted internal building temperatures determined to be comfortable to the occupants of the building.

The temperature versus time of day graph 230 illustrates the conventional heating method temperature (conventional method temperature) 222 and an example heating method embodiment of the present disclosure temperature (example method temperature) 224. As illustrated, the conventional heating method includes heating the buildings internal temperature so that the conventional method temperature 222 is within the comfort range 234 by the beginning of the occupancy period (e.g., where the occupancy line 238 converges to the set point 236). The conventional method temperature 222 is further raised to achieve the set point temperature 236 early in the occupancy period. However, in the illustrated example the weather conditions in the building location are such that they are causing the internal temperature of the building to rise. Since the building in the illustrated example is in a temperate climate and does not employ temperature chilling measures, the internal building temperature continues to rise throughout the occupancy period and conventional method temperature 222 exceeds the comfort range 234 halfway through the occupancy period resulting in discomfort for the occupants of the building throughout the remainder of the occupancy period.

As discussed with regard to FIG. 1, the attribute monitoring system can generate and/or execute a conditioning schedule based on a prediction of how the temperature of the building will respond to a weather condition included in a weather forecast. In the example illustrated in FIG. 2, the attribute monitoring system has received a forecast for the building's location and has predicted at what rate the weather conditions included in the forecast will result in the internal temperature of the building rising. In this example, the building attribute manager is executing a schedule generated based on the predicted behavior of the attribute in the example illustrated in FIG. 2. The building attribute manager in the example illustrated in FIG. 2 is causing the heating of the internal air of the building resulting in the example method temperature 224 reaching a point just below the bottom bound of the comfort range 234 during the beginning of the occupancy period. Thereafter, the example method temperature 224 is gradually raised into the comfort range 234. Weather conditions continue to gradually raise the example method temperature 224 in the manner predicted by the building attribute manager. Conditioning the internal building temperature according to the generated schedule allows the weather condition to perform a portion of the work to increase the example method temperature 224 to the set point 236 and prevents the weather condition from causing the example method temperature 224 to exceed the comfort range 234. Therefore, while briefly and minimally compromising comfort at the beginning of the occupancy period the buildings internal temperature is maintained within the comfort range 234 the remainder of the day.

The lower portion of the graph 220 includes an energy consumption graph 232. The energy consumption graph 232 has an x-axis including the time of day and a y-axis including the energy consumed in conditioning the internal temperature. The energy consumption graph 232 can include the energy that is consumed by a building heating, ventilation, and air conditioning system in heating the building. The energy consumed does not include the energy transferred as a result of the weather conditions acting on the building, but only reflects the generated energy consumed in artificially conditioning the building temperature.

The energy consumption graph 232 illustrates the energy consumed in heating the building according to a conventional heating method 226 and corresponds to the conventional method temperature 222 of the temperature versus time of day graph 230. The energy consumption graph 232 also illustrates the energy consumed in heating the building according to an example embodiment of the heating method of the present disclosure 228 and corresponds to the example method temperature 224 of the temperature versus time of day graph 230. That is, the energy consumed in heating the building according to a conventional heating method 226 and the energy consumed in heating the building according to an example embodiment of the heating method of the present disclosure 228 illustrate the energy consumed in the corresponding illustrated changes to the conventional method temperature 222 and the example method temperature, respectively.

Heating the building according to a heating method of the present disclosure 228 consumes less energy and occurs over a shorter duration than heating the building according to a conventional heating method 226. The energy consumption graph 232 demonstrates an energy savings of a conditioning method of the present disclosure over conventional methods. The energy savings can directly translate to a cost savings.

In various embodiments, the principle can be applied either via a single-step reinforcement, two-step reinforcement, or dynamic modelling and/or dynamic programming. All of them can consider an overall criterion which can, for example, be a combination of operational costs and indoor discomfort.

The single-step reinforcement can be based on a look up-table that can, for example, be continuously updated. This look-up table, for example, can store values of the overall criterion for the average forecasted outdoor air temperature and/or time when heating started. In some embodiments, this table can be filled automatically every day. The table can be initiated by some safe experiments with the starting time.

Once the look-up table contains sufficient data, it is possible to find out the starting time that minimizes the overall criterion for the actual weather forecast. In some embodiments, the look-up table can be replaced by an adaptive mapping (ensample of local models or recursive regression).

The two-step reinforcement can, for example, perform the optimization into two steps. The first step can, for example, be to learn a look-up table that contains the starting times for given (average daily) weather forecast and indoor zone temperature at the beginning of the occupied period. This look-up table can, for example, be filled by data based on some safe experimentation with the starting time.

The second step can, for example, be to construct another look-up table that contains the value of the overall criterion for given (average daily) weather forecast and zone air temperature at the beginning of the occupied period. This look-up table can be filled in parallel with the first one.

After both look-up tables contain sufficient data, it is possible find out the zone air temperature that reduces or minimizes the overall criterion for the given weather forecast. Then, it is possible to calculate the corresponding starting time.

The process can combine efficiently different modeling approaches: for example to use polynomial recursive regression for the starting times, but a discretized look-up table for the criterion.

The principle can be used for the combination of dynamic modeling and dynamic programming. The dynamic modeling can, for example include three things: forecasting disturbances, building thermal modeling, and cost function construction.

The forecasted disturbances such as outdoor air temperature or building occupancy can be provided by external sources, possibly corrected by local data and eventually including some information on the uncertainty. The thermal building modeling can leverage well known RC models that capture also unmeasured temperatures (e.g. walls).

An overall criterion—the loss function—can be created. Partly, it has to reflect information available in the documentation (e.g. power tariffs), partly is based on black-box modeling of the HVAC operation.

This black-box model quantifies the energy used for a specific thermal situation in the building after changing the zone air setpoints. After a dynamic model is provided, the optimal profile of the considered attribute (e.g. indoor air temperature setpoint) is calculated by means of dynamic programming. The attribute is quantized. In order to simplify the calculation and the state space, it is possible to use non-stationary version of the dynamic programming instead of the stationary one. This can make some variables implicit (e.g. outdoor air temperature).

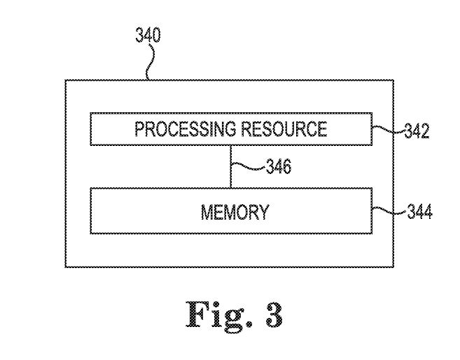

FIG. 3 illustrates a diagram of an example computing device 340 in accordance with the present disclosure. The computing device 340 can utilize software, hardware, firmware, and/or logic to perform functions described herein.

The computing device 340 can include a processing resource 342 and a memory 344. The memory 344 can be volatile or nonvolatile memory. The memory 344 can also be removable (e.g., portable) memory, or non-removable (e.g., internal) memory. For example, the memory 344 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

The processing resource 342 can include any number of processors capable of executing instructions stored by the memory 344. Processing resource 342 can be implemented in a single device or distributed across multiple devices. The program instructions (e.g., computer readable instructions (CRI)) can include instructions stored on the memory 344 and executable by the processing resource 342 to implement a function (e.g., monitor an attribute of a building; monitor a weather forecast; predict a behavior of the attribute based on the weather forecast; generate a building conditioning schedule to maintain the attribute within a comfort range relative to a set point of the attribute during a time period based on the predicted behavior; etc.).

The memory 344 can be in communication with the processing resource 342 via a communication link (e.g., a path) 346. The communication link 346 can be local or remote to a machine (e.g., a computing device) associated with the processing resource 342. Examples of a local communication link 346 can include an electronic bus internal to a machine (e.g., a computing device) where the memory 344 is one of volatile, non-volatile, fixed, and/or removable storage medium in communication with the processing resource 342 via the electronic bus.

In some embodiments, the computing device 340 can include a user-interface (not illustrated by FIG. 3). A user-interface can include hardware components and/or computer-readable instruction components for a user to interact with a computing device 340.

In some embodiments, the computing device 340 can include one or more input components. A user may enter commands and information into the computing device 340 through the input component. Example input components can include a keyboard, mouse and/or other point device, touch screen, microphone, scanner, wireless communication, etc. The input components can be connected to the computing device 340 through an interface, such as a parallel port, game port, or a universal serial bus (USB). A screen or other type of display device can also be connected to the system via a user interface, such as a video adapter. The screen can display graphical user information for the user.

The computing device 340 can correspond to one or more elements of FIG. 1. For example, the computing device 340 can include CRI that when executed by the processing resource 342 can function as a control system of FIG. 1. For example, the computing device 340 can include CRI that when executed by the processing resource 342 can monitor an attribute of a building. The computing device 340 can also include CRI that when executed by the processing resource 342 can monitor a weather forecast. The computing device 340 can include CRI that when executed by the processing resource 342 can predict a behavior of the attribute based on the weather forecast. Additionally, the computing device 340 can include CRI that when executed by the processing resource 342 can generate a building conditioning schedule to maintain the attribute within a comfort range relative to a set point of the attribute during a time period based on the predicted behavior.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for maintaining an attribute of a building, comprising:
monitoring an attribute of a building;
predicting a behavior of the attribute based on a weather forecast; and
adjusting the attribute to maintain the attribute within a comfort range relative to a set point for the attribute during a time period based on the predicted behavior.

2. The method of claim 1, wherein the method includes receiving the weather forecast from a weather forecasting service via a network.

3. The method of claim 1, wherein the attribute is an internal temperature of the building.

4. The method of claim 3, wherein adjusting the attribute includes raising the internal temperature to a temperature below the set point sufficient to prevent a weather condition from causing the internal temperature to exceed the comfort range during the time period.

5. The method of claim 1, wherein the building is a commercial building.

6. The method of claim 1, wherein the building is a residential building.

7. A non-transitory computer readable medium storing instructions executable by a processing resource to cause a computer to:
monitor an attribute of a building;
monitor a weather forecast;
predict a behavior of the attribute based on the weather forecast; and
generate a building conditioning schedule to maintain the attribute within a comfort range relative to a set point of the attribute during a time period based on the predicted behavior.

8. The non-transitory computer readable medium of claim 7, wherein the instructions are executable by the processing resource to cause the computer to monitor the attribute of the building by monitoring an internal temperature of the building via a temperature sensor during a weather condition.

9. The non-transitory computer readable medium of claim 8, wherein the instructions are executable by the processing resource to cause the computer to generate a thermal response model of the building to a plurality of weather conditions based on the internal temperature of the building during the weather condition.

10. The non-transitory computer readable medium of claim 9, wherein the instructions are executable by the processing resource to cause the computer to predict the behavior of the attribute based on a weather condition included in the weather forecast and the thermal response model.

11. The non-transitory computer readable medium of claim 9, wherein the instructions are executable by the processing resource to continuously update the model based on an updated internal temperature reading during an updated weather condition.

12. The non-transitory computer readable medium of claim 7, wherein the instructions are executable by the processing resource to monitor the weather forecast by retrieving a weather forecast daily.

13. The non-transitory computer readable medium of claim 12, wherein the instructions are executable by the processing resource to generate the building conditioning schedule daily based on the retrieved weather forecast.

14. The non-transitory computer readable medium of claim 7, wherein the building conditioning schedule is a schedule for heating the building.

15. The non-transitory computer readable medium of claim 14, wherein the time period is an occupancy period of the building.

16. A system for maintaining an attribute of a building, comprising:
a forecasting system configured to receive a weather forecast; and
a building monitoring system configured to:
monitor an internal temperature of a building;
predict how the internal temperature of the building will respond to a weather condition included in a weather forecast; and
generate a building conditioning schedule to maintain the internal temperature of the building within a predetermined temperature range relative to a set point during an occupancy period of the building based on the prediction.

17. The system of claim 16, wherein the prediction is based on the internal temperature of the building during a plurality of weather conditions.

18. The system of claim 16, wherein the conditioning schedule includes heating the building to an internal temperature below the predetermined range for the start of the occupancy period.

19. The system of claim 16, wherein the conditioning schedule includes heating the building to an internal temperature below the set point and allowing the weather condition to bring the temperature to the set point.

20. The system of claim 16, wherein the set point is a predetermined target temperature and the temperature range is a predetermined targeted comfort range.
